(19) United States
(12) Patent Application Publication
(10) Pub. No.: US 2005/0026661 A1
(43) Pub. Date: Feb. 3, 2005

(54) Multiple persistency provisioning and/or customization of mobile electronic devices using smart covers

(76) Inventors: Simone Van Rheenen, Redmond, WA (US); G. Eric Engstrom, Kirkland, WA (US); Peter Zatloukal, Kirkland, WA (US); Boon Hwang, San Rafael, CA (US)

Correspondence Address: SCHWABE, WILLIAMSON & WYATT, P.C.;PACWEST CENTER, SUITES 1600-1900, 1211 SW FIFTH AVENUE, PORTLAND, OR, 97204, US

(21) Appl. No.: 10/903,468

(22) Filed: Jul. 30, 2004

Related U.S. Application Data
(63) Continuation-in-part of application No. 10/428,815, filed on May 2, 2003.
Application No. 10/428,815 is a continuation-in-part of application No. 09/933,858, filed on Aug. 20, 2001.
Application No. 10/428,815 is a continuation-in-part of application No. 10/087,098, filed on Mar. 1, 2002.
Application No. 10/428,815 is a continuation-in-part of application No. 09/932,154, filed on Aug. 17, 2001, now Pat. No. 6,721,545.
Application No. 10/428,815 is a continuation-in-part of application No. 10/000,170, filed on Nov. 30, 2001.
Application No. 10/428,815 is a continuation-in-part of application No. 10/301,431, filed on Nov. 20, 2002.
Application No. 10/428,815 is a continuation-in-part of application No. 10/346,017, filed on Jan. 16, 2003.
Application No. 10/428,815 is a continuation-in-part of application No. 10/367,620, filed on Feb. 14, 2003.
(60) Provisional application No. 60/306,326, filed on Jul. 17, 2001.
(60) Provisional application No. 60/292,123, filed on May 17, 2001.
(60) Provisional application No. 60/418,925, filed on Oct. 15, 2002.

(51) Int. Cl. H04M 1/00

(52) U.S. Cl. 455/575.8

(57) ABSTRACT

A cover of a mobile electronic device is provided with data or location information for retrieving the data, to provide or customize a plurality of functionality of the mobile electronic device, including at least a first provision or customization that is semi-persistent, conditionally effective when the cover is not mated with the device after an initial mating. In various embodiments, the mobile electronic device includes a repository to store the data associated with the semi-persistent provisions or customizations, and facilities for a user to select a previously mated cover, and/or a function associated with a previously mated cover. In various embodiments, the cover may be a housing cover or an accessory cover.

### RELATED APPLICATION

This application is a continuation-in-part application to U.S. patent application Ser. No. 10/428,815, filed May 2, 2003, entitled “Personalization of Mobile Electronic Devices Using Smart Accessory Covers”, which itself is a continuation-in-part application of:

(a) U.S. patent application Ser. No. 09/933,858, filed Aug. 20, 2001, entitled “Interchangeable Cover For a Mobile Communication Device”;

(b) U.S. patent application Ser. No. 10/087,098, filed Mar. 1, 2002, entitled “PERSONALIZING ELECTRONIC DEVICES AND SMART COVERING”, which itself claims priority to its provisional filing No. 60/306,326, filed on Jul. 17, 2001;

(c) U.S. patent application Ser. No. 09/932,154, filed Aug. 17, 2001, entitled “MOBILE ELECTRONIC DEVICE AND COVERING FOR SIMILAR DEVICES WITH ORNAMENT ATTACHMENT MECHANISM”, which itself claims priority to its provisional filing No. 60/292,123, filed on May 17, 2001;

(d) U.S. patent application Ser. No. 10/001,170, filed Nov. 30, 2001, entitled “Avoiding Attachment of Ineligible Smart Interchangeable Cover To An Electronic Device”;

(e) U.S. patent application Ser. No. 10/301,431, filed Nov. 20, 2002, entitled “Adding Control Keys to Mobile Devices Via Smart Interchangeable Cover”, which itself claims priority to its provisional filing No. 60/418,925, filed on Oct. 15, 2002;

(f) U.S. patent application Ser. No. 10/346,071, filed Jan. 16, 2003, entitled “INTERCHANGEABLE COVERING ADDITIONS TO A MOBILE COMMUNICATION DEVICE FOR DISPLAY AND KEY REORIENTATION”; and

(g) U.S. patent application Ser. No. 10/365,620, filed Feb. 14, 2003, entitled “PERSONALIZING ELECTRONIC DEVICE AND SMART COVERING”.

This continuation-in-part application claims priority to the above enumerated applications. The specifications of the above enumerated applications are hereby fully incorporated by reference, to the extent the specifications are consistent or complementary to the specification of this continuation-in-part application.

### FIELD OF INVENTION

The invention relates to the field of electronic devices. More specifically, the invention relates to multiple persistency provisioning and/or customization, including personalization, of mobile electronic devices using smart covers.

### BACKGROUND OF THE INVENTION

With the proliferation of electronic devices, especially mobile electronic devices, such as, mobile phones, hand-held personal computers (PC), and so forth, these devices have gained the status of personal appliances to a person. As a result, increasingly, users desire to personalize these devices. For example, in addition to a wide variety of body casing colors, interchangeable faceplates of various colors and artistic designs are available for a variety of mobile phones to allow the users to have even greater choices providing different physical appearances to their own devices. Additionally, a variety of non-standard screen-savers and ring tones can be downloaded into the devices to further personalize the devices. Similarly, hand-held personal computers and personal digital assistants also come in various colors, with various screen savers and wallpapers.

These approaches to personalization suffer from a number of disadvantages. First, they are disjoint. Typically, a user may go to a mall or an online e-commerce site to shop and purchase, e.g. a faceplate with design and/or color that is of interest to the user. Then, the user may go online to web sites to search and look for a custom ring tone or a screen saver of interest to the user. It is the user's responsibility to choose and combine the appropriate hardware, i.e. faceplate design/color, with the software behavior, i.e. custom ring tone etc. to create a total personality. The process is cumbersome for many users, especially for the more novice users, as the proliferation of mobile electronic devices reaches more and more users. Moreover, the approaches do not facilitate quick and timely changes to the personality to be taken on by the mobile electronic devices. These shortcomings apply equally to personalization of other electronic devices, such as game consoles.

Additionally, personalization is just a specie of provisioning or customizing functions of a mobile electronic device. Thus, the problems described above exist in general for the genus subject of provisioning and/or customizing functions to mobile electronic devices.

### BRIEF DESCRIPTION OF DRAWINGS

The invention is illustrated by way of example embodiments, and not by way of limitation in the figures of the accompanying drawings, in which like references indicate similar elements and in which:

FIGS. 1A-1E comprise various views of a smart accessory cover for a mobile phone in accordance with a first embodiment;

FIGS. 2A-2B and 3 illustrate views of a mobile phone adorned with the smart accessory cover of FIGS. 1A-1E;

FIG. 4A-4B and 5 depict various views of a smart accessory cover in accordance with a second embodiment;

FIGS. 6A and 6B are isometric views used to illustrate how a mobile phone is adorned with a smart accessory cover of FIGS. 1A-1E or FIGS. 4A-4B and 5;

FIGS. 7A and 7B are isometric views of a mobile phone suitable for adorning the smart accessory covers of FIGS. 1A-1E or FIGS. 4A-4B and 5;

FIGS. 8A and 8B are isometric views of a variant of the smart accessory cover of FIGS. 1A-1E or FIGS. 4A-4B and 5 that uses a plurality of latches to assist a mobile phone in adorning the smart accessory cover;

FIGS. 9A and 9B are isometric views illustrating another variant of the smart accessory cover of FIGS. 1A-1E or FIGS. 4A-4B and 5, in which an inwardly extending protrusion is defined in the smart accessory cover;

FIG. 10 is an isometric view of another variant of the smart accessory cover of FIGS. 1A-1E or FIGS. 4A-4B and 5, in which an opening and optional lens are included in a smart accessory cover to enable a user to view a display on the mobile phone adorning the smart accessory cover;

FIG. 11 illustrates an architectural view of the internal electronic components of an exemplary mobile phone, suitable for practicing embodiments of the present invention;

FIGS. 12A & 12B illustrate the operational flow of the relevant aspects of the operating logic of a mobile phone, suitable for practicing embodiments of the present invention;

FIGS. 13A-13E illustrate an example application of one aspect of the present invention, personalizing a mobile phone to a singer celebrity theme, in accordance with various embodiments;

FIGS. 14A-14F illustrate another example application of one aspect of the present invention, personalizing a mobile phone to a sport celebrity theme, in accordance with various embodiments.

FIG. 15 is an isometric view of an embodiment of the invention in which the smart accessory cover is adapted to be adorned by a PDA device or a pocket PC, in accordance with various embodiments;

FIG. 16 is an isometric view of an embodiment of the invention in which the smart accessory cover is adapted to be adorned by a two-way wireless pager, in accordance with various embodiments;

FIGS. 17a-17b illustrate two example end user interface elements for a locker feature, in accordance with various embodiments;

FIG. 18 illustrate the operational flow of the logic in support of the locker feature, in accordance with various embodiments.

### DETAILED DESCRIPTION OF THE INVENTION

For ease of understanding, embodiments of the present invention will be primarily described in the context of wireless mobile phones. However, it is anticipated that the present invention may be practiced on a wide range of other mobile electronic devices, including but are not limited to wireless pagers, game consoles, media players, and other devices of the like. Accordingly, references to wireless mobile phones in the description to follow are merely illustrative, and are not to be read as limitations to the claims.

Similarly, for ease of understanding, embodiments of the present invention will also be primarily described in the context of accessory covers. However, it is anticipated that the present invention may be practiced on housing covers. The former, i.e. accessory covers, are covers not required to complete the underlying mobile electronic devices, which themselves are complete and operational with or without the accessory covers. Whereas, the latter, i.e. housing covers, are covers required to complete the underlying mobile electronic devices, without them, the underlying devices are incomplete and substantially non-operational.

In the following description, various aspects of various embodiments of the invention will be described. However, it will be apparent to those skilled in the art that alternate embodiments may be practiced with only some or all aspects. For purposes of explanation, specific numbers, materials and configurations are set forth in order to provide a thorough understanding of the embodiments. However, it will also be apparent to one skilled in the art that alternate embodiments may be practiced without the specific details. In other instances, well-known features are omitted or simplified in order not to obscure the invention.

Parts of the description will be presented in terms commonly employed by those skilled in the art to convey the substance of their work to others skilled in the art. In particular, the terms “wireless mobile phone” and “mobile phone” as used herein (the specification as well as the claims) refer to the class of telephony devices equipped to make and receive calls wirelessly, notwithstanding movement, as long as the device is within the communication reach of a service or base station of a wireless network service provider. Unless specifically excluded, these terms are to include the analog subclass as well as the digital subclass (of all signaling protocols).

Terms such as instructions, data, and the like, refer to quantities that may take the form of electrical, magnetic, or optical signals. These signals may be stored, transferred, combined, and otherwise manipulated through mechanical, electrical and/or optical components of the devices.

Various operations will be described as multiple discrete operations in turn, in a manner that is most helpful in understanding the embodiments, however, the order of description should not be construed as to imply that these operations are necessarily order dependent. In particular, these operations need not be performed in the order of presentation.

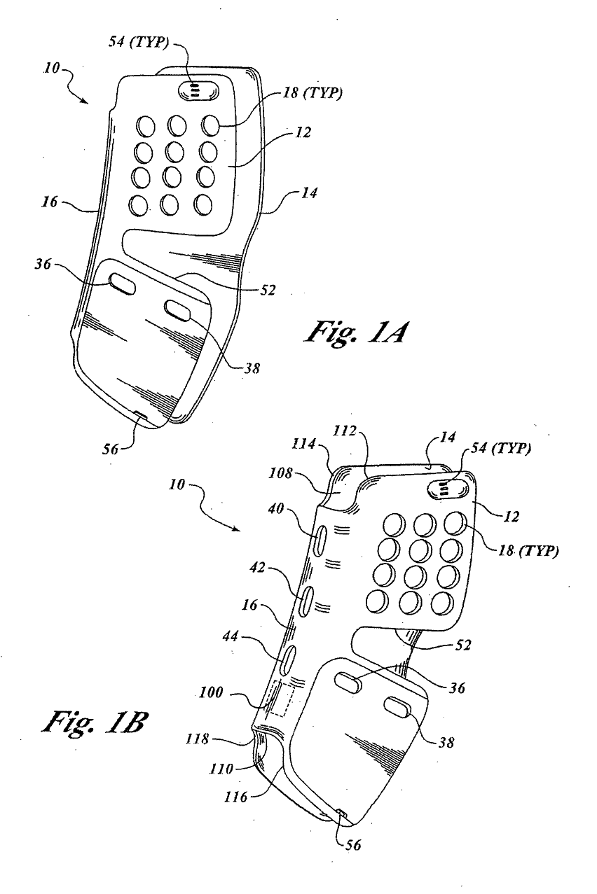

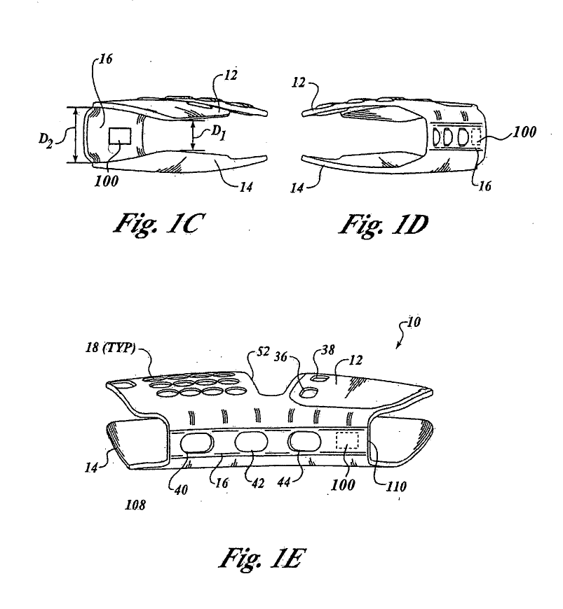

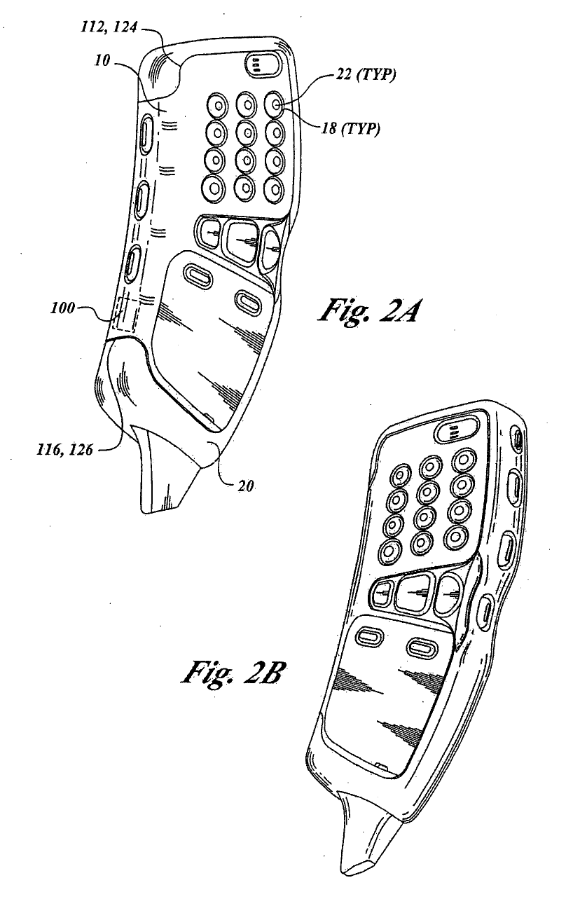

Referring now to FIGS. 1A-E, a smart accessory cover 10 in accordance with a first embodiment of the invention is shown. Smart accessory cover 10 incorporated with the teachings of the present invention is designed to enable a complementarily shaped and dimensioned mobile phone to be provisioned and/or customized, including personalized, in an improved and more user friendly manner not available under the prior art.

As will be described in more detail below, in various embodiments, smart accessory cover 10 may include physical designs (typically thematic) depicted on its exterior surfaces, and complementary instructions and/or data disposed in integrated electronic components, to enable a mobile phone adorning smart accessory cover 10 to be provisioned/customized physically as well as behaviorally.

For the present application, physical provisioning/customization refers to the outward appearance of the mobile phone, e.g. its color, graphics depicted on the exterior surfaces, and so forth. Whereas behavioral provisioning/customization refers to the provisioning/customization of the functionalities of the mobile phone, e.g. modification of its ring tone, wall paper, screen savers, and so forth.

As will be also further described in detail below, smart accessory cover 10 is an “accessory” cover designed to be adorned by a targeted mobile phone. Smart accessory cover 10 is designed to provision/customize the adorning mobile phone as an “accessory”, as jewelries, scarf, and so forth designed to be adorned to provision/customize clothing for style and look, and insulation jackets, sleeves, and so forth designed to be adorned to enhance the insulation attribute of a hot beverage container. As jewelries and scarf are entities separate and distinct from the underlying clothing, insulation jackets and sleeves are entities separate and distinct from the underlying hot beverage container, so is smart accessory cover 10, an entity separate and distinct from the targeted mobile phones.

Smart accessory cover 10 is not a required element to complete the underlying mobile phone. As clothing may be worn without accessory jewelries or scarf, or a hot beverage container may be used without an additional insulation jacket/sleeve, in like manner, under the present invention, a targeted mobile phone may be used without any smart accessory cover 10. In particular, smart accessory cover 10 is not an element of the housing of a targeted mobile phone.

Accordingly, smart accessory cover 10 may also be referred to as smart accessory jacket, smart accessory sleeve or other descriptive terms of the like.

Further, the term “cover” as used herein refers to a part that inherently includes multiple surfaces that substantively cover at least multiple ones of the exterior surfaces of the target mobile device, where the exterior surfaces are inherently disposed in different geometric planes. Accordingly, while a “cover” may come in many variants, as illustrated by the description to follow, a “card” like part, i.e. a part having the form factor of a “credit card”, a PCMCIA card, a PC card, a Compact Flash card and so forth, a “faceplate” or a “back plate” is not a “cover”, for the purpose of the present application. A “card” or “plate” like part, for the purpose of the present application, by definition, is considered to occupy only one geometric plane. To the extent, a “plate” covers any geometric planes orthogonal to the main plane, the coverage is typically insubstantial or deminimus. [PCMCIA=Personal Computer Memory Card International Association]

For ease of understanding, hereinafter instructions and/or data shall simply be referred to as data. Accordingly, usage of the term “data”, including in the claims, unless the context clearly denote otherwise, may include instructions as well as data.

Continuing to refer to FIGS. 1A-1E, for the embodiment, smart accessory cover 10 comprises a resilient semi-rigid shell having a front face 12 and a back face 14 commonly connected to a side portion 16. As illustrated, smart accessory cover 10 has a substantially “U”-shaped profile. As used herein, substantially “U”-shaped means there are two extending portions connected to a base portion that is substantially perpendicular to the extending portions, and wherein there is a bevel or radius where each extending portion joins the base portion.

In one embodiment, the extending portions of the “U” are rotated toward each other such that a distance D1 between the end portions of the “U” is less than a distance D2 at the root of the “U”.

As explained in further detail below, this configuration is adapted to enable smart accessory cover 10 to clasp around a complementary mobile phone, which in one embodiment, has a substantially trapezoidal profile.

Smart accessory cover 10 includes in particular, electronic component 100 incorporated with data (or instructions to obtain such data) to provision and/or customize, such as personalize, the functionalities of a targeted mobile phone, to be described more fully below. In various embodiments, electronic component 100 may be a memory, such as electrically erasable programmable read only embedded memory (EEPROM), compact flash, a smart card, a processor or controller having embedded memory, or a system-on-chip having a processor, embedded memory, and other function blocks.

As illustrated, for the embodiment, electronic component 100 is disposed in the inside surface of side surface 16, designed to mate with a “connector” complementarily disposed on a targeted mobile phone. The “connector” may be any one of a number of coupling interface known in the art or to be designed, including but are not limited to parallel or serial interfaces.

In alternate embodiments, the present invention may be practiced employing more than one electronic component, and/or more than one complementary connectors disposed to the targeted mobile phone. Further, the one or more electronic components may be disposed in other locations and/or surfaces of smart accessory cover 10.

Mechanically, for the embodiment, smart accessory cover 10 includes a plurality of openings 18 through which respective keypad buttons on a target mobile phone may pass, upon adornment of the smart accessory cover by the mobile phone.

For example, a configuration wherein a smart accessory cover 10 is adorned by a mobile phone 20 including a plurality of keypad buttons 22 is shown in FIGS. 2A and 2B.

Openings 18 enable a user to activate keypad buttons 22 of the mobile phone 20, even after mobile phone 20 has adorned smart accessory cover 10.

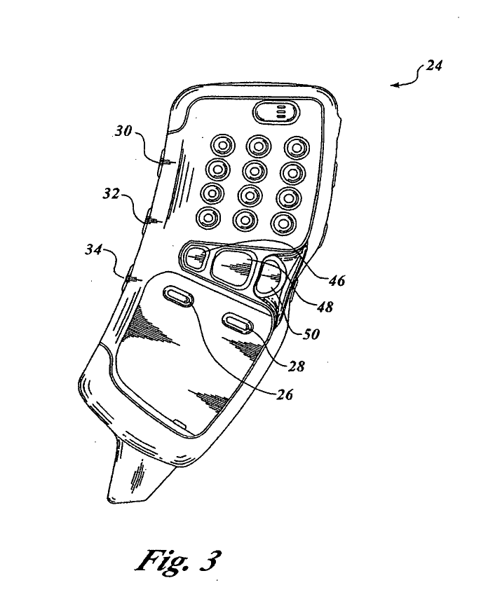

In some configurations, the mobile phone adorning the smart accessory cover may include various input buttons in addition to keypad buttons. For example, a mobile phone 24 depicted in FIG. 3 adorning a smart accessory cover 10 includes buttons 26 and 28 on its face, and side input buttons 30, 32, and 34 on its side.

Accordingly, smart accessory cover 10 further includes slots 36 and 38 defined in front face 12, and slots 40, 42 and 44 defined in side portion 16.

Mobile phone 24 also may include additional buttons, including buttons 46, 48 and 50, disposed at a mid-portion of its front surface.

In order to accommodate access to these buttons, smart accessory cover 10 may further include a radiused “V”-shaped cutout 52.

As depicted in FIGS. 1A and 1B, for the embodiment, smart accessory cover 10 also includes one or more speaker slots 54 through which audible signals produced by the mobile phone's speaker may pass, and a microphone slot 56 through which a user's voice may be detected by the mobile phone's microphone.

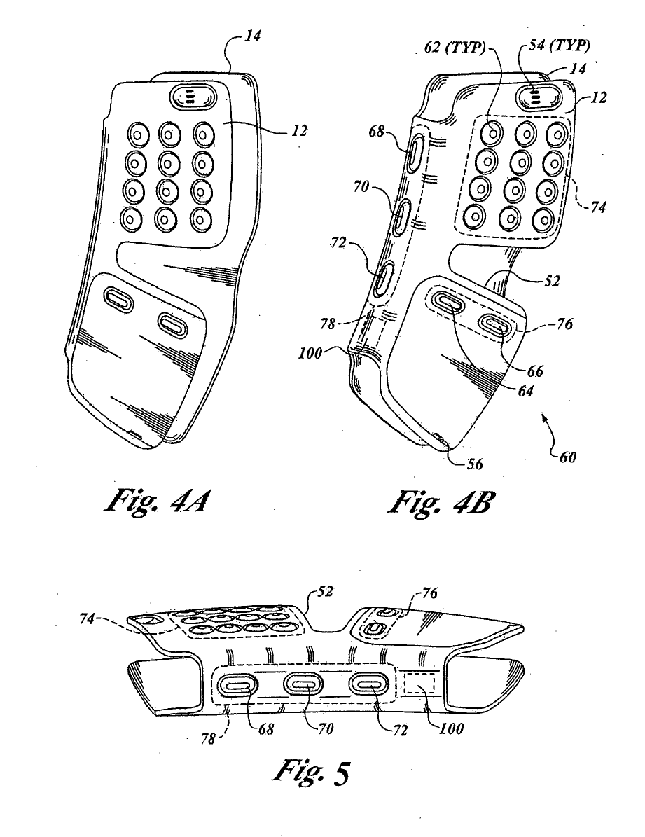

FIGS. 4A-B and 5 illustrate a smart accessory cover 60 in accordance with a second embodiment of the invention. In general, smart accessory cover 60 is substantially similar in configuration to smart accessory cover 10, except that smart accessory cover 60 includes “dumb” buttons that enable corresponding buttons built into the mobile phone (e.g., buttons 61 shown in FIG. 7A) to be actuated via a user pressing on the dumb buttons. Accordingly, like-numbered components in both sets of figures perform substantially the same functions in both configurations.

The dumb buttons include a plurality of dumb keypad buttons 62, dumb input buttons 64 and 66, and side input buttons 68, 70, and 72. In one embodiment, the input buttons comprise a thin membrane sheet in which a plurality of domes are defined, wherein each dome includes a center portion extending below the dome is pressed by a user. These membrane sheets are depicted in FIG. 4B as a membrane sheet 74, a membrane sheet 76, and a membrane sheet 78. The various membrane sheets may be secured to the underside of the smart accessory cover using one of various assembly methods, including but are not limited to the use of appropriate adhesive.

In alternate embodiments, dumb buttons 62 in conjunction with data provided through electronic component 100 may also be employed to reorient the operational relative disposition of the keypad and the display screen of a targeted mobile phone. The elements may be employed to e.g. reorient the target mobile phone from a first operational orientation with the keypad disposed below the display screen to a second operational orientation with the keypad disposed above the display screen, or vice versa.

That is, the keypad of the targeted mobile phone may be labeled for the first operational orientation with the keypad to be disposed below the display screen, and dumb buttons 62 are labeled for the second operational orientation with the keypad to be disposed above the display screen, to support the functional reorientation provided through the data in electronic component 100.

Re-orientation of a mobile device using a smart interchangeable cover is the subject matter of the above identified parent application Ser. No. 10/346,071.

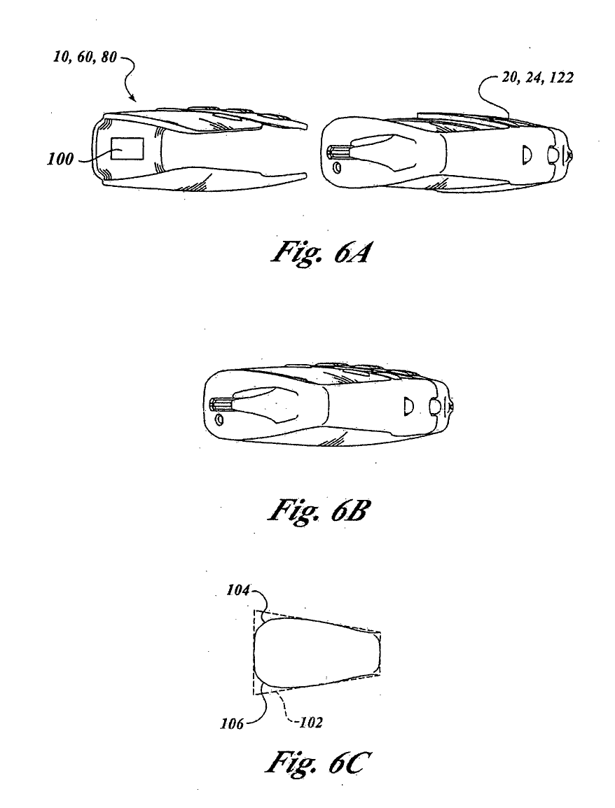

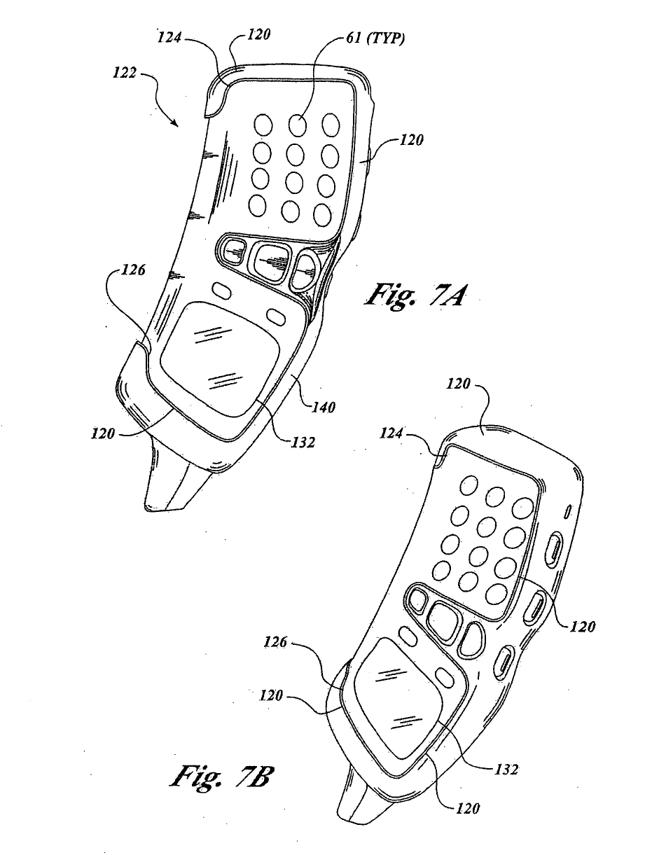

As discussed above, smart accessory covers 10 and 60 are adorned by a mobile phone such that they “clasp” around the profile of the mobile phone. This adornment process is illustrated in FIGS. 6A and B. In one embodiment, the profile of the mobile phone (e.g. mobile phone 20) has a radiused trapezoid configuration, as illustrated by a trapezoid 102 in FIG. 6C. The trapeziod-shaped profile also includes radiused corners 104 and 106.

As the leading edges of front face 12 and back face 14 contact radiused corners 104 and 106, respectively, upon adornment of smart accessory cover 10 or 60 by the mobile phone, the leading edges of the front and back faces are caused to be spread apart, enabling smart accessory cover 10 or 60 to be slid over the mobile phone. As the user slides smart accessory cover 10 or 60 further over the mobile phone, the resilient material used for smart accessory cover 10 or 60 causes smart accessory cover 10 or 60 to return to its undeformed configuration, adorning smart accessory cover 10 or 60 to the mobile phone.

In addition to adorning smart accessory cover 10 or 60 to the mobile phone based on the phone's trapezoidal profile, other securing provisions may also be implemented. For example, in one embodiment a pair of “U”-shaped notches 108 and 110 may be defined toward opposing ends of side portion 16, as shown in FIGS. 1B and 1E. Notches 108 and 110 may be configured to engage with portions of peripheral lips defined in the front and back faces of the mobile phone over which smart accessory cover 10 or 60 is to be adorned, such as shown by a peripheral lip 120 defined in the mobile phone, as illustrated in FIGS. 7A and 7B. A substantially similar peripheral lip is formed into the backside of mobile phone 122, as well (not shown).

In one embodiment, notch 108 includes shoulders 112 and 114, while notch 110 includes shoulders 116 and 118. Upon adornment, shoulder 112 engages a radius 124 formed in peripheral lip 120, while shoulder 114 engages a similar radius defined in the peripheral lip on the backside of the phone. Similarly, shoulder 116 engages a radius 126 formed in peripheral lip 120, while shoulder 118 engages a similar radius defined in the peripheral lip on the backside of the mobile phone.

Furthermore, as these radiused portions of smart accessory cover 10 or 60 slide passed their respective shoulders, at least one audible “click” is heard corresponding to a mechanical engagement of the adjacent features.

Details of the adorned configuration are shown in FIGS. 2A and 2B.

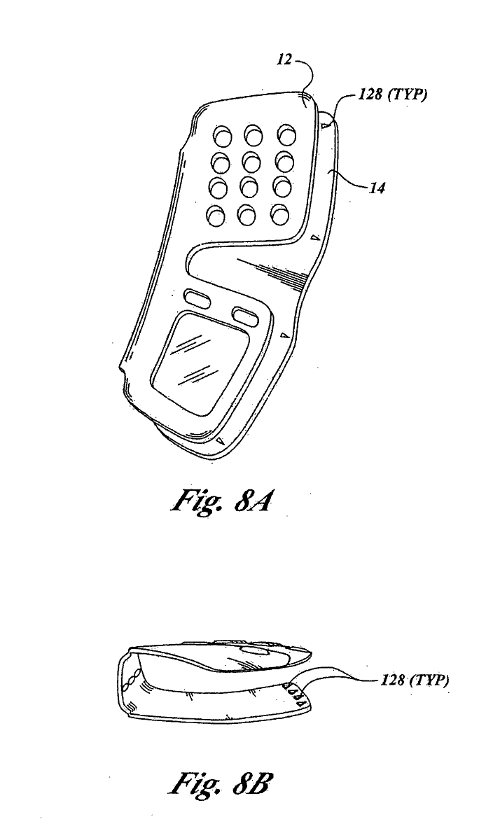

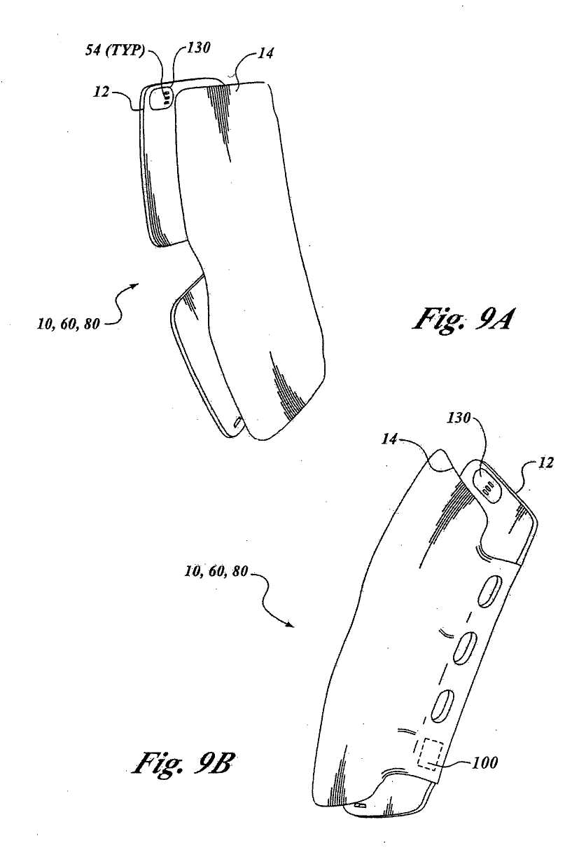

A second means for providing assistance in the mobile phone in adorning smart accessory cover 10 or 60 includes a plurality of latches 128, which may be defined in a peripheral portion of the inside surfaces of other or both of front face 12 and back face 14, as shown in FIGS. 8A and 8B.

As shown in the detail of FIG. 8B, in one embodiment each of latches 128 have a triangular profile. A set of adjacent recesses designed to receive the latches are defined in the mobile phone.

Upon adornment, latches 128 latch into respective recesses defined in the mobile phone to assist in adorning smart accessory cover 10 or 60 to the mobile phone.

A third means for providing assistance in adorning smart accessory cover 10 or 60 to the mobile phone comprises the use of one or more inwardly extending protrusions that are define in front face 12 and/or back face 14.

An example protrusion 130 is shown in FIGS. 9A and 9B. A recess having a configuration adapted to receive the protrusion is defined in the mobile phone such that the protrusion(s) fit into (a) respective recess(es) defined in the front and/or back sides of the mobile phones.

As depicted in FIGS. 9a and 9B, in one embodiment speaker slot 54 are defined within a protrusion.

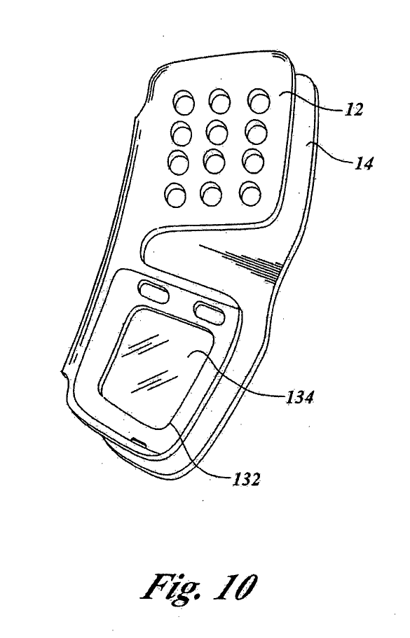

Mobile phone 122 may also include a display 132 in which text and/or graphical data are displayed. For example, display 132 may comprise an LCD. Accordingly, smart accessory cover 10 or 60 may include a cutout 132 configured to provide viewing access to display 132 upon adornment, as shown in FIG. 10.

Optionally, a lens 134, preferably made of a clear, impact resistant material, may be disposed in cutout 132.

Material-wise, smart accessory cover 10 or 60 may be made of any material that provides the desired resilient properties, such as various plastics, including but not limited to, polycarbonate, acrylonitrile butadiene styrene (ABS), or a polycarbonate/ABS blend.

When a plastic is used, smart accessory cover 10 or 60 may be manufactured using well-known plastic manufacturing techniques, such as injection-molding. Electronic component 100 is placed thereon afterwards.

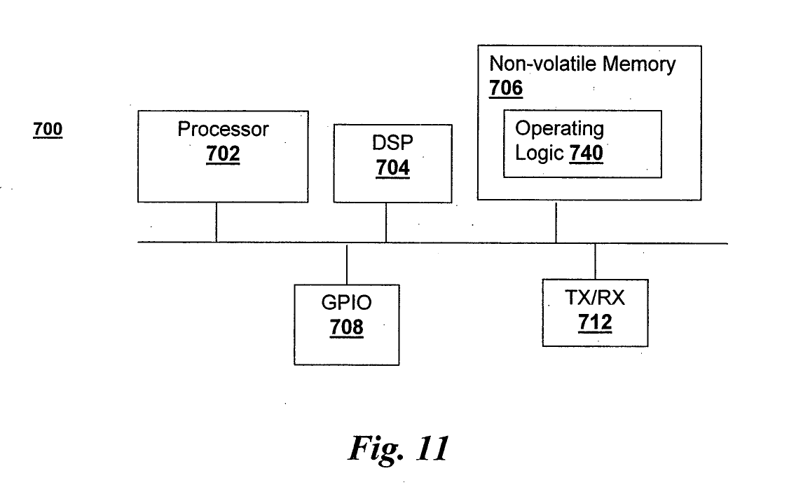

Having now described the mechanical aspects of smart accessory cover 10 and 60, electronic component 100, or more specifically, its contents, and the process of provisioning/customizing (e.g. personalizing) a targeted mobile phone will now be described. Before doing so, the architecture of an example target mobile phone will first be described referencing FIG. 11. Further, the smart accessory cover of the present invention, and the targeted mobile phones are not limited to the U and trapezoidal shapes nor the uni-body constructions of the above described embodiments. The present invention may be practiced with the smart accessory cover and the targeted mobile phones having other shapes, including but not limited to rectangular, triangular, circular, oval, and so forth, and non-uni-body constructions, as in the case of “flip phones” or other multi-portion body constructions.

Referring now to FIG. 11, for the exemplary embodiment, mobile phone 700 includes elements such as processor 702, digital signal processor (DSP) 704, non-volatile embedded memory 706, general-purpose input/output (GPIO) interface 708, and transmit/receive (TX/RX) 712 coupled to each other as shown.

Non-volatile memory 706 is employed to store programming instructions and optionally, working data, including in particular, operating logic 740. Working data may include callee/messaging party or parties (e.g. their phone numbers or IP addresses) with whom user may communicate. Working data may also include provisioning/customizing (e.g personalization) data obtained from, or in accordance with the instructions in electronic component 100. In various embodiments, operating logic 740 includes support for persistent, semi-persistent and/or transient provisioning/customization of functions by a smart cover. The support may be factory provided or field installed, including downloaded from a server and/or a mated smart cover.

The phrase “persistent provisioning/customization of functions” refers to the type of provisioning/customizing of functions where the provisioning/customization of functions caused by a smart cover (typically as a result of an initial mating with the smart cover) are effective regardless whether the smart cover remains mated with the underlying mobile phone. That is, the provisioning/customizations are effective while the smart cover is mated with the underlying mobile phone, and remain effective even after the smart cover has been removed, and is no longer currently mated with the underlying mobile phone. Examples of these provisioning/customizations include but are not limited to an update to a system component or a relatively “low value” content asset.

The phrase “semi-persistent provisioning/customization of functions” refers to the type of provisioning/customizing of functions where the provisioning/customization of functions caused by a smart cover (typically as a result of an initial mating with the smart cover) are effective while the smart cover is mated with the underlying mobile phone, otherwise, the provisioned/customized functions are reversed (typically on removal of the smart cover), and thereafter (i.e. after the smart cover has been removed, and is no longer currently mated with the underlying mobile phone), conditionally rendered effective from time to time, as appropriate. Examples of these semi-persistent provisioning/customization of functions include but are not limited to provisioning and/or customizing certain features and/or behaviors of the end user interface, e.g. wall paper, screen saver and so forth. In other words, the provisioning/customization of the functions are reversed on removal of the smart cover, however, the data and/or instructions associated with these semi-persistent provisioning/customization of functions remain with the mobile phone, and they are conditionally re-applied as appropriate (even if the mobile phone is now mated with another cover having another theme).

In various embodiments, the provisioning/customization of functions are re-applied when the mobile phone is used by a user to perform a function that is associated with a previously mated smart cover. A previously mated smart cover is a smart cover having mated with the mobile phone at least once, and is not currently mated with the with the mobile phone. Examples of these functions include but are not limited to calling a number that is related to a theme of a previously mated smart cover, sending a SMS message to a recipient that is related to the theme, accessing a website that is related to the theme (including streaming video/audio from the website), and so forth. The content/webpage may be provided/rendered using any one of a number of coding (rendering) techniques, and/or messaging (networking) protocols. The former may include, but are not limited to, HTML, WML, XHTML, cHTML and the like, while the latter may include, but are not limited to HTTP, WAP, HTTPS, and so forth.

The phrase “transient provisioning/customization of functions” refers to the type of provisioning/customizing of functions where the provisioning/customization of functions caused by a smart cover are effective only if the smart cover is mated with the underlying mobile phone, otherwise, the provisioning/customizations of functions are reversed. In various embodiments, the data and/or instructions associated with transient provisioning/customization of functions may be deleted from the mobile phone. In other embodiments, the data and/or instructions associated with the transient provisioning/customization of functions may be merely disabled. Examples of the transient provisioning/customization of functions may include but are not limited to provisioning of high value contents.

Still referring to FIG. 11, processor 702, assisted by DSP 704, is employed to operate phone, executing operating logic 740, including provisioning and/or customization instructions obtained from, or in accordance with the instructions in electronic component 100. As described earlier, the provisioning and/or customization may be persistent, semi-persistent or transient.

GPIO 708 may be employed to interface with a number of input devices, such as keypad, scroll buttons and so forth, including in particular, with electronic components 100 to facilitate transfer of provisioning/customizing (e.g personalization) data to and from electronic component 100.

TX/RX 712 may be employed to transmit and receive communication signals for a call and/or a text message. TX/RX 712 may be a radio frequency transceiver, and support one or more of any of the known signaling protocols, including but are not limited to CDMA, TDMA, GSM, and so forth.

Except for their novel usage to facilitate the practice of the present invention, the constitutions of these elements are known, and will not be further described.

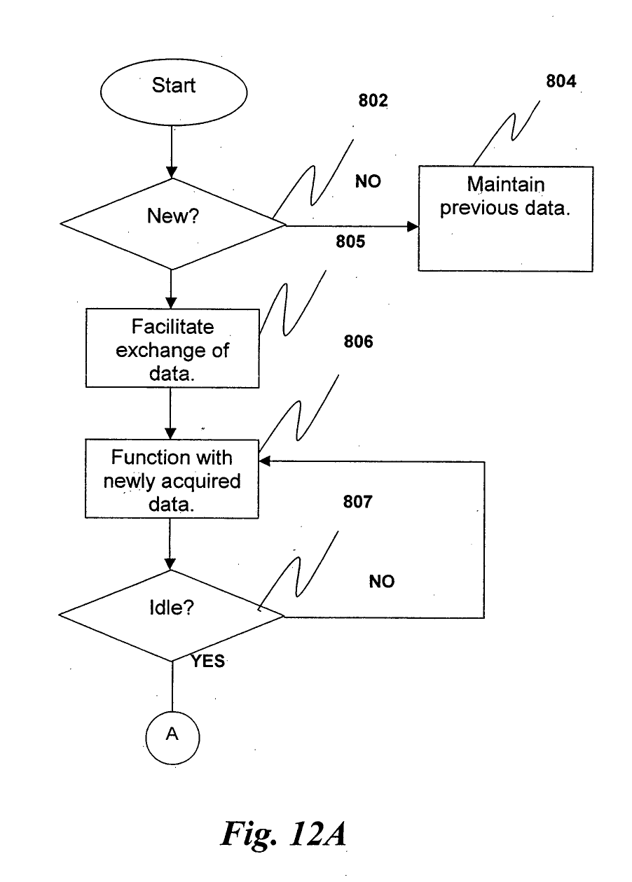

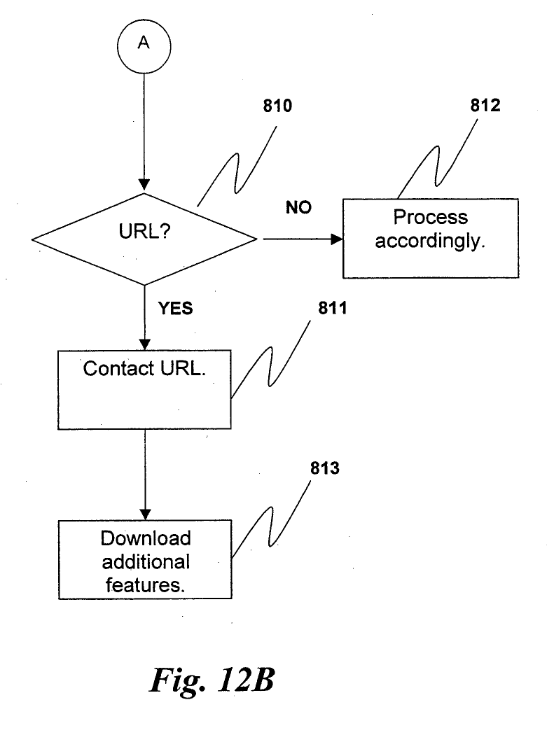

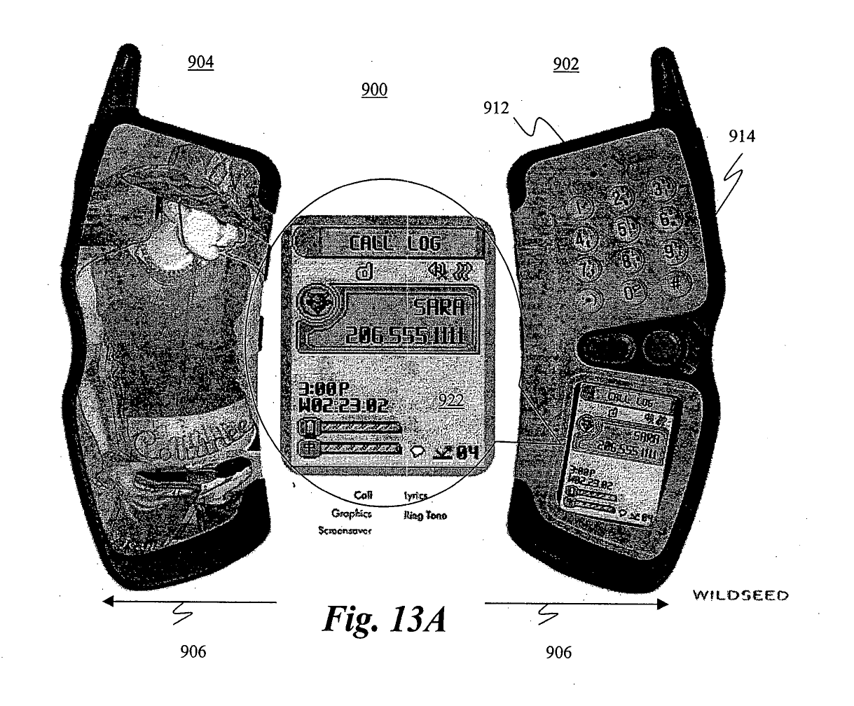

FIGS. 12A & 12B illustrate the operational flow of the relevant aspects of operatic logic 740 of phone 700 to take advantage of the provisioning/customization (e.g. personalization) data stored in electronic component 100 of smart accessory cover 10 or 60. Mobile phone 700 is assumed to be adorning smart accessory cover 10 or 60.

Accordingly, as illustrated in FIG. 12A, on initialization, at e.g. power on or reset, operating logic 740 checks for the presence of a new smart accessory cover 10 or 60 with embedded electronic component 100 having provisioning/customizing (e.g. personalizing) data, block 802.

Once it is determined that the mobile phone is adorned with a new smart accessory cover 10 or 60, an exchange of data between the new smart accessory cover 10 and 60 and the mobile phone is facilitated, block 805. The exchange of data may be made between e.g. a processor of the mobile phone and embedded electronic component 100 within smart accessory cover 10 or 60.

During this exchange, provisioning/customization data/instructions, e.g. personalization data complementary to the provisioning/customization (e.g. personalizing) theme of the smart accessory cover 10 or 60, may be provided to the mobile phone, block 806. Additionally, during the exchange, a resource server specification may be provided to the mobile phone. This resource server specification may be utilized by the mobile phone to contact the resource server for additional data. The contact may be made immediately or at a later point in time.

In various embodiments, some of the provisioning and/or customization, such as modification of the ring tone or wall paper, may immediately take effect as soon as they are provided to the mobile phone.

In an embodiment where some of the provisioning and/or customization data are obtained at a later deferred point in time, the mobile phone determines appropriate “idle” opportunity, after the immediate provisioning and/or customization has been put into effect, block 807. In various embodiments, the “idle” opportunity may be a predetermined period when the usage of the mobile phone is below a predetermined de-minimus threshold.

Back at block 802, if there is no new coupling between the mobile phone and a new smart accessory cover 10 or 60, operating logic 704 may maintain a previously installed data complementing a previous provisioning/customizing (e.g. personalizing) theme until a presence of a new smart accessory cover 10 or 60 with embedded provisioning/customizing (e.g. personalizing) data is detected (especially if the previously installed data are provided by currently mated smart cover), block 804. Additionally, a portion of operating logic 740 operates to conditionally re-render effective any semi-persistent provisioning and/or customization provided by a previously mated smart cover.

Referring now to FIG. 12B, if an “idle” opportunity is available, operating logic 740 may determine if the resource server specification is in the form of an URL, block 810. If the resource server specification is in the form of an URL, the processing of the URL involves contacting a resource server containing data related to provisioning/customization (e.g. personalization), block 811.

Once the resource server is contacted, operating logic 740 may wirelessly access the resource server, and acquire the additional provisioning and/or customization data to further complement the provisioning and/or customization theme, block 813.

However, if the retrieved data is not in the form of an URL, operating logic 740 may process the non-URL resource specification accordingly to retrieve the additional provisioning and/or customization instruction and/or data, block 812.

Furthermore, if no additional provisioning and/or customization data are available, operating logic 740 may continue to function with only the persistent and semi-persistent provisioning and/or customization data acquired from current and prior embedded component 100, block 806 (shown in FIG. 12A). The operating flow of operating logic 740 in support of previously acquired semi-persistent provisioning and/or customization data will be further described below.

In various embodiments, the provisioning and/or customization data may be provided from electronic component 100 of a smart accessory cover 10 or 60 to an adorning mobile phone in a secured manner, i.e. through a secure content exchange process/protocol. One approach is disclosed in the above identified parent application, Ser. No. 10/001,170.

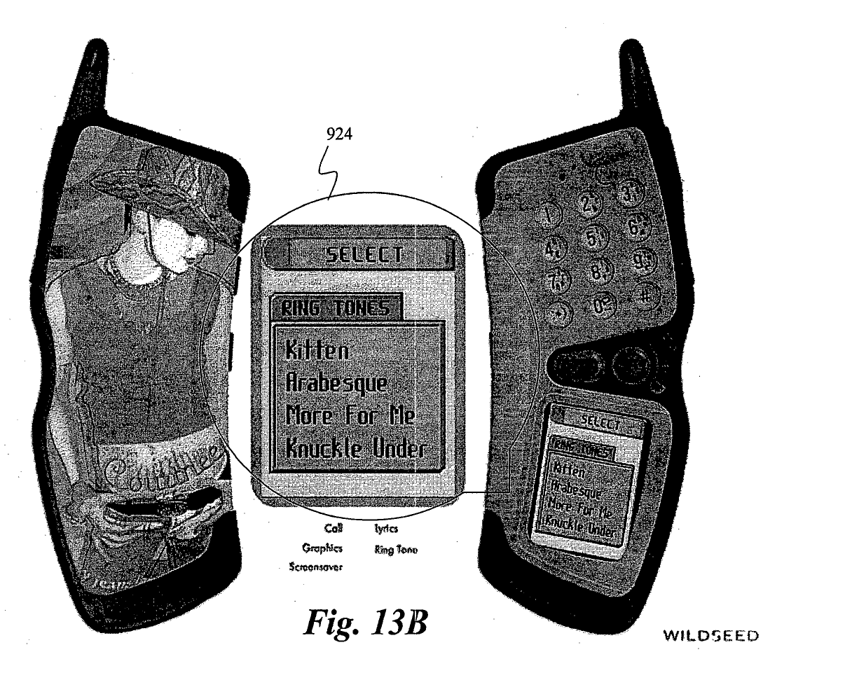

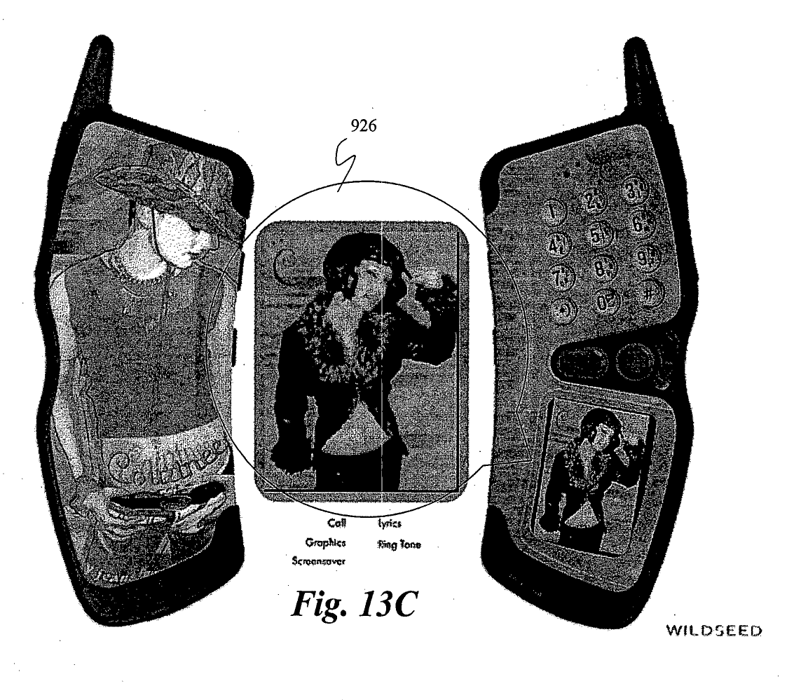

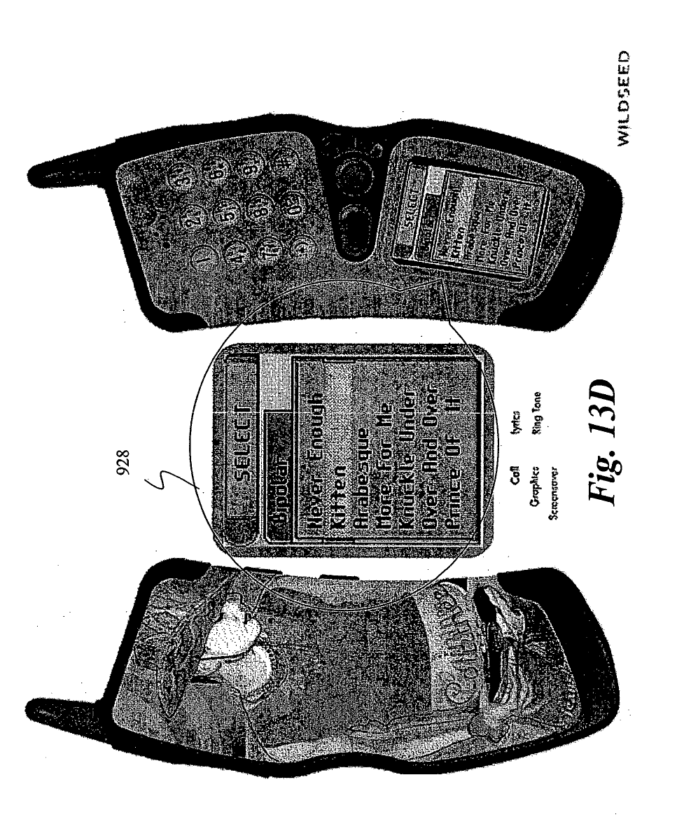

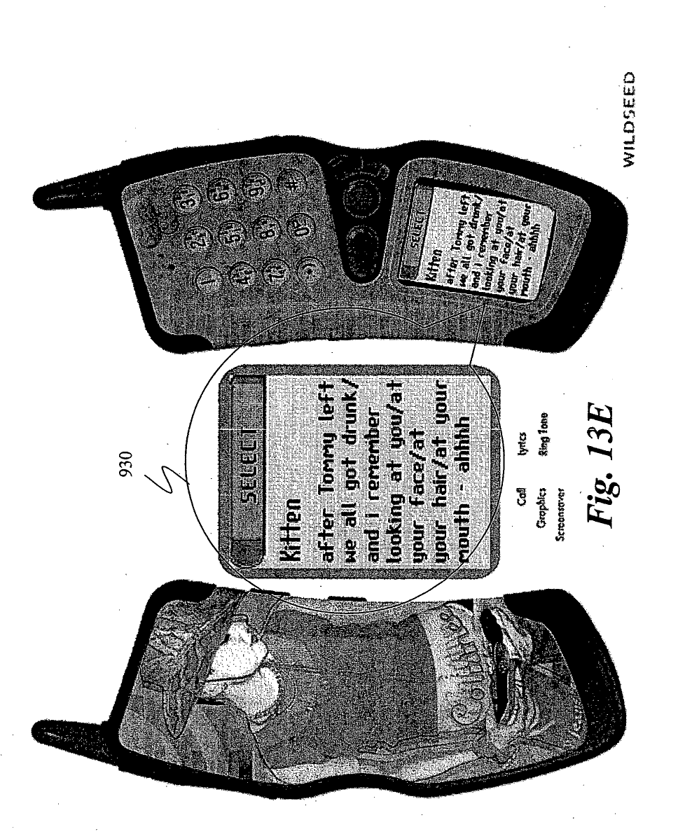

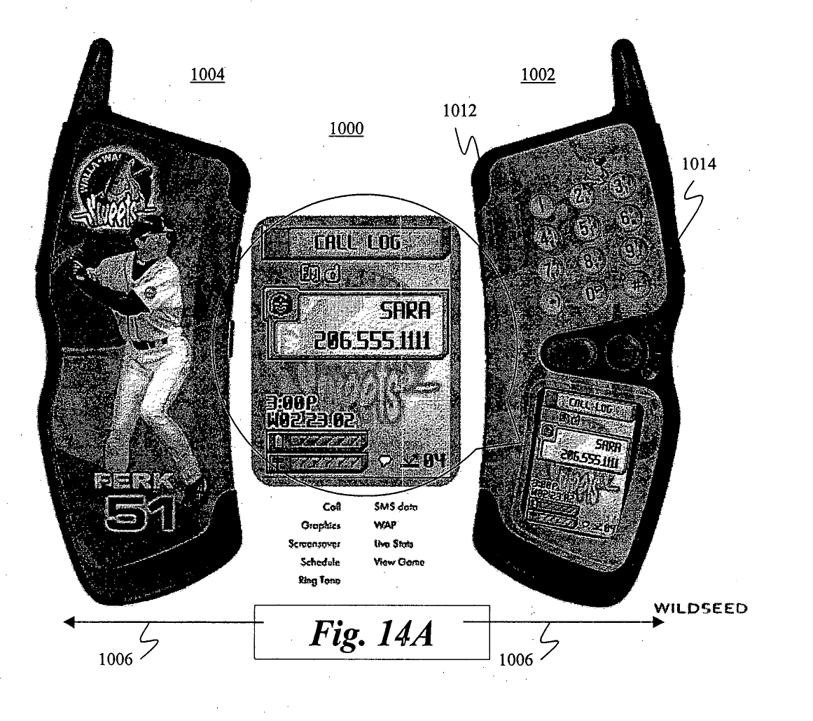

FIGS. 13a-13e illustrate an example application of the present invention, personalizing a wireless mobile phone 900 to a celebrity singer theme. Shown in FIG. 13a is a front view 902 and a back view 904 of wireless mobile phone 900 having a boomerang shaped body 912, mated with smart accessory cover 914 incorporated with the teachings of the present invention. For the embodiment, smart accessory cover 914 is substantially U-shaped, designed to snap onto body 912 in a sideway direction 906, to mate with body 912.

As illustrated and described earlier, the exterior surface of smart accessory cover 914 is decorated with graphic design to visually convey the celebrity singer theme. The celebrity singer may be any one of a number of past, present, or future famous singers, male or female, of rock n roll, country, pop, jazz, rap or classical music.

As described earlier, smart accessory cover 914 includes an electronic component (not visible) having data (or a portion thereof) that personalize the functionalities and/or behaviors of wireless mobile phones 900 to the celebrity singer theme, or location data identify where the data (or the remainder) may be obtained.

The personalization may include personalizing “wallpaper” 922 and providing ring tones using audio segments extracted from audio materials, such as songs, of the celebrity 924 (FIG. 13b) in support of the celebrity singer theme. The personalization may further include providing video and/or picture of the celebrity 926 (FIG. 13c), providing audio materials, such as songs, of the celebrity 928 (FIG. 13d), as well as providing lyrics of the provided songs 930 (FIG. 13e). One or more of the provided pictures may be used as a screensaver.

The pictures, audio and video may be in any one of a number of compressed formats. For example, in the case of pictures, the compressed format may be JPEG, GIF and so forth. Audio may be encoded as MP3 files. Video may be encoded in accordance to MPEGx. Location data to retrieve all or a portion of the personalization data may be an URL identifying the data hosting server.

As described earlier, portions of the personalization may be persistent, while others are semi-persistent and/or transient.

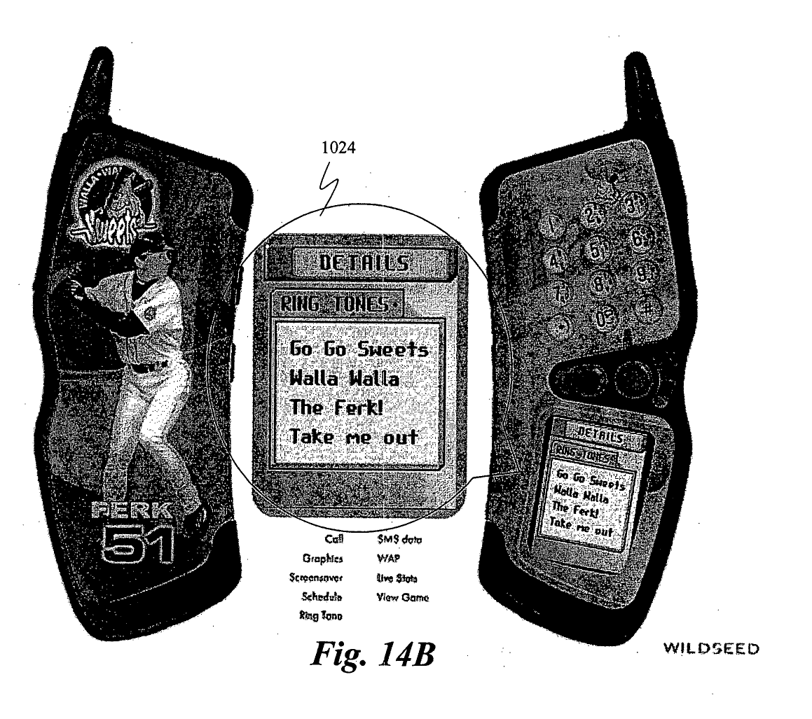

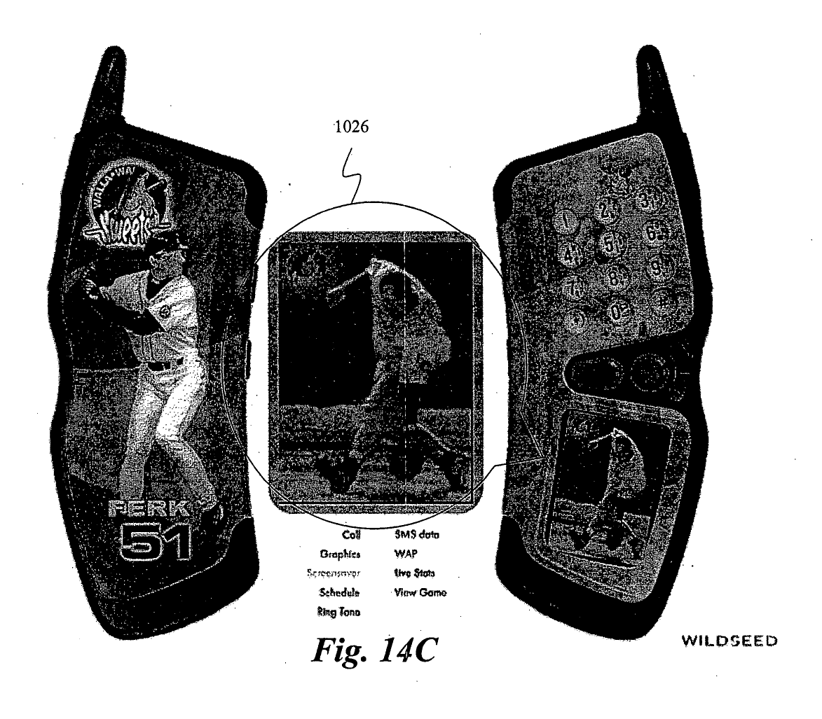

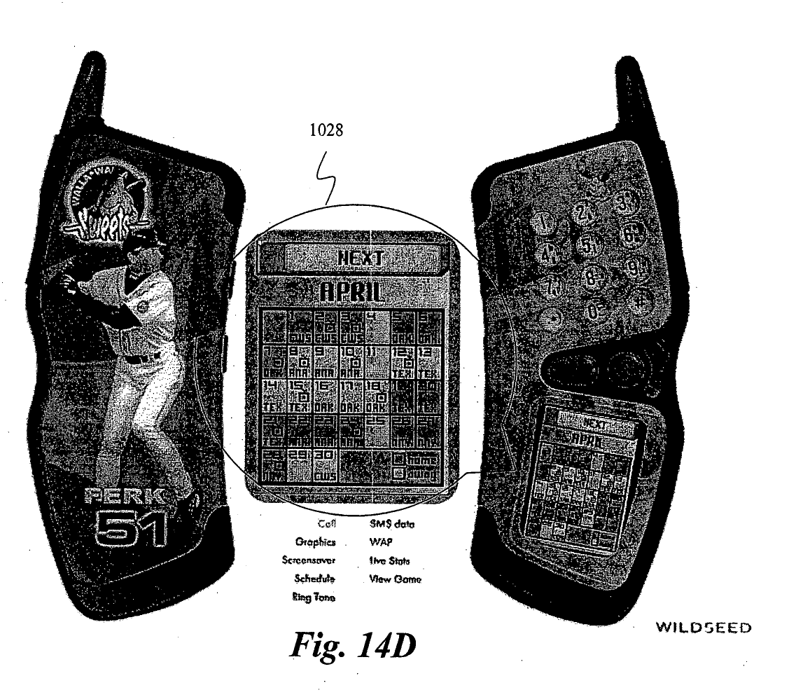

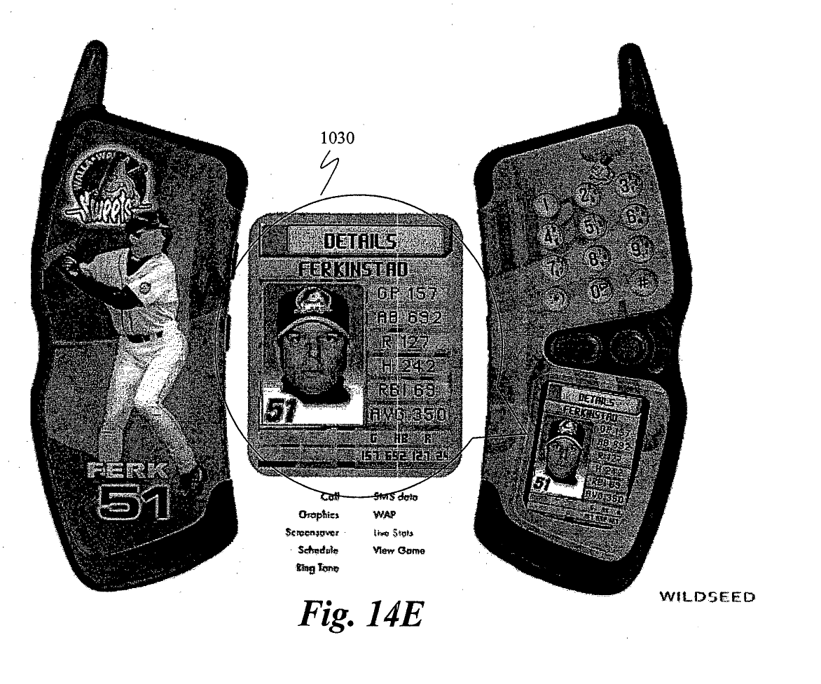

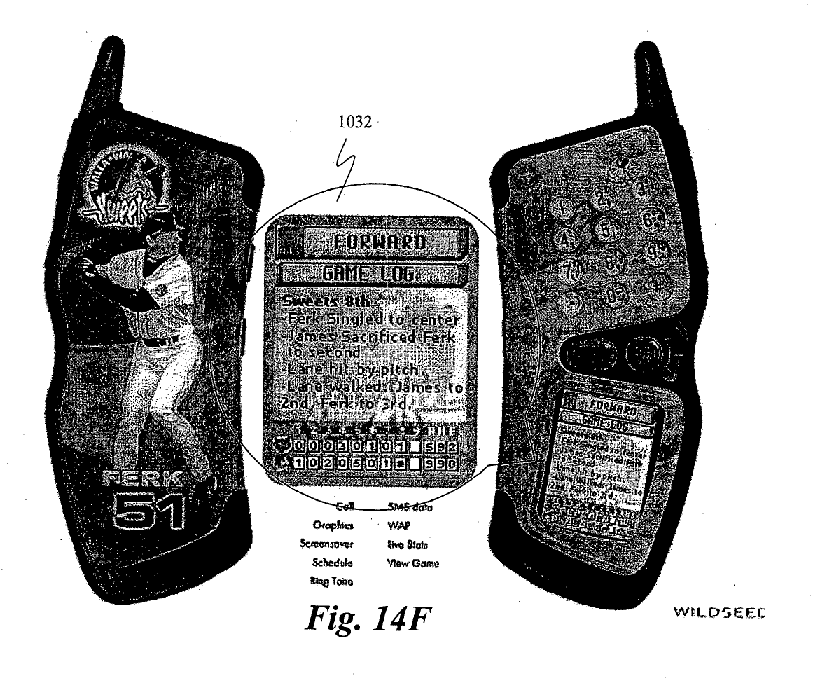

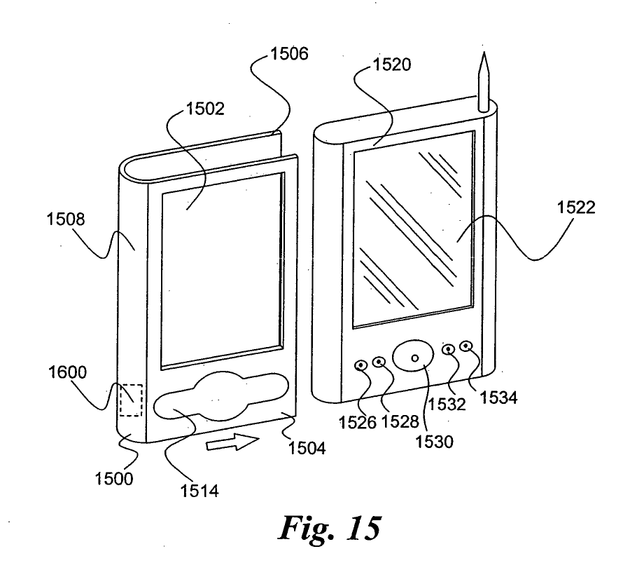

FIGS. 14a-14f illustrate another example application of the present invention, personalizing a wireless mobile phone 1000 to a celebrity sport figure theme. Shown in FIG. 14a is a front view 1002 and a back view 1004 of wireless mobile phone 1000 having a boomerang shaped body 1012, mated with smart accessory cover 1014 incorporated with the teachings of the present invention. For the embodiment, smart accessory cover 1014 is substantially U-shaped, designed to snap onto body 1012 in a sideway direction 1006, to mate with body 1012.

As illustrated and described earlier, the exterior surface of smart accessory cover 1014 is decorated with graphic design to visually convey the celebrity sport figure theme. The celebrity sport figure may be any one of a number of past, present and future famous sport figures, male or female, of the sport of baseball, basketball, football, soccer, ice hockey, figure skating, tennis, and so forth.

As described earlier, smart accessory cover 1014 includes an electronic component (not visible) having data (or a portion thereof) that personalize the functionalities and/or behaviors of wireless mobile phones 1000 to the celebrity sport figure theme, or location data identify where the data (or the remainder) may be obtained.

The personalization may include personalizing “wallpaper” 1022 and providing ring tones using audio segments extracted from audio materials, such as songs, consistent with the sport 1024 (FIG. 14b) in support of the celebrity sport figure theme. The personalization may further include providing video and/or pictures of the celebrity sport FIG. 1026 (FIG. 14c), providing game schedule of the celebrity sport figure's team 1028 (FIG. 14d), providing statistics of the celebrity sport FIG. 1030 (FIG. 14e), as well as logic to access a current and/or past game log 1032 (FIG. 14f). One or more of the provided pictures and game schedules may be used as a screensaver.

The game schedules, game log and other data of like may be retrieved from a remote server. Similarly, portions of the personalization may be persistent, while others are semi-persistent and/or transient.

In various embodiments, embedded electronic component 100 may also include data to provide electronic coupons that allow a user of the wireless mobile phone to obtain discounts on purchases of items or services, e.g. by calling a provided telephone number, and/or accessing a website identified by a provided URL. The items or services may be related to the personalizing theme of the smart accessory cover, or related to the business of advertisers or sponsors of the smart accessory cover.

In yet other embodiments, embedded electronic component 100 may also include data to implement a font complementing the personalizing theme of the smart accessory cover. The font may correspond to personalizing themes, such as, but not limited to, an alien font from a science fiction series, and so forth.

Still in other embodiments, embedded electronic component 100 may also include data to access and/or communicate with members of a community related to the theme, e.g. accessing a BLOG, sending SMS messages to the members and/or officers/contacts of the community.

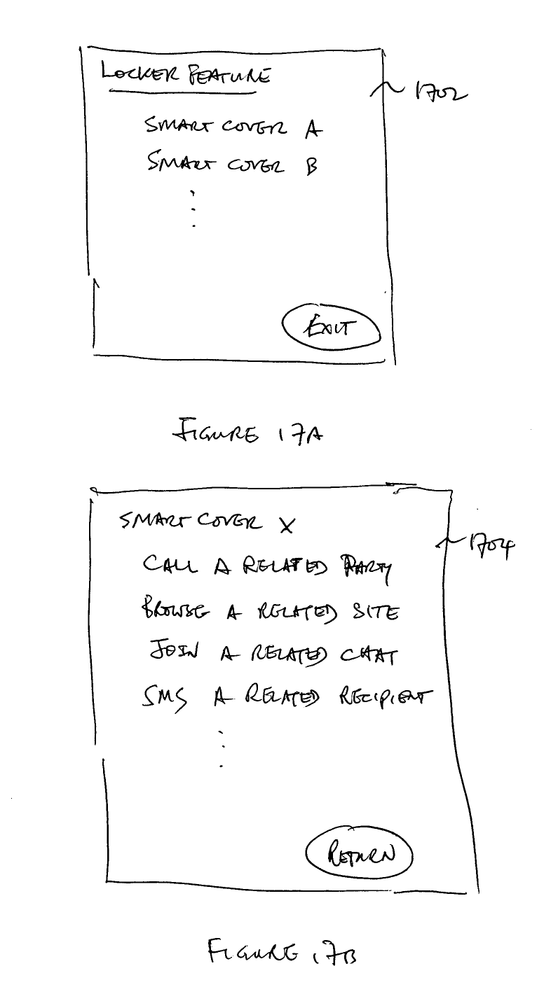

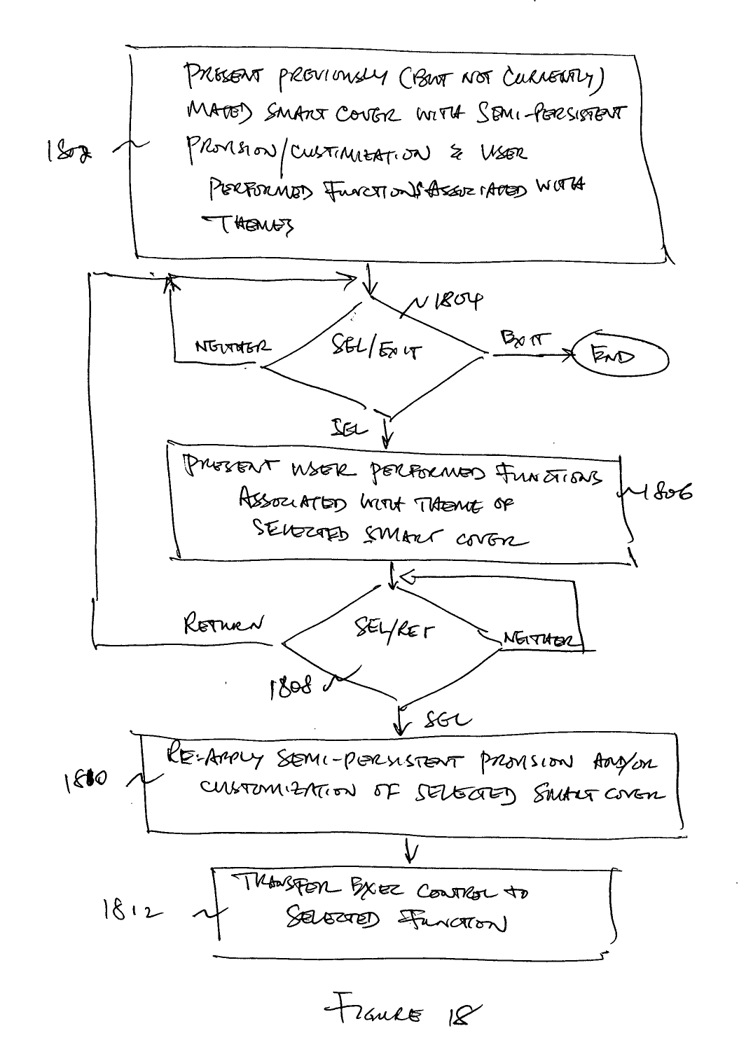

Referring now to FIGS. 17a-17b and 18, wherein two elements of a user interface, and the operation flow of operating logic 740 in support of semi-persistent provisioning and/or customization (including personalization) of functions, are illustrated, respectively, in accordance with various embodiments. For ease of understanding, the feature will be referred to as a locker feature.

More specifically, FIG. 17a illustrates an example list 1702 employed by operating logic 740 to present for a user previously mated smart covers with semi-persistent provision and/or customization. List 1702 may be presented in response to a user selection of the locker feature. Selection of the locker feature may be implemented in any conventional feature selection manner.

FIG. 17b illustrates another example list 1704 employed by operating logic 740 to present for a user with a list of functions and/tasks a user may perform, that are associated with the themes of the previously mated smart covers with semi-persistent provision and/or customization. List 1704 may be presented in response to a user selection of the previously mated smart cover, using e.g. list 1702.

FIG. 18 illustrates an example operation flow of operating logic 704 in support of semi-persistent provision and/or customization. As illustrated, for the embodiments, on invocation of the locker feature, operating logic 704 presents a list of previously mated smart covers with semi-persistent provisions and/or customizations, and user performed functions associated with the themes of the smart cvers, block 1802. Thereafter, operating logic 704 awaits selection of one of the smart covers by the user, or an instruction to exit the locker feature, block 1804. On selection of one the smart covers, operating logic 704 proceeds to block 1806.

At block 1806, operating logic 704 presents a list of user performed functions associated with the theme of the selected previously mated smart covers. In like manner, thereafter, operating logic 704 awaits selection of one of the functions, or an instruction to return to the previously mated smart cover list, block 1808. On selection of one the user performed functions, operating logic 704 proceeds to block 1810.

At block 1810, operating logic 704 re-applies the semi-persistent provision and/or customization of the selected previously mated smart cover. Thereafter, operating logic 704 transfers execution control to the instructions implementing the selected function, block 1812. Operation continues from there.

Back at block 1808, if an instruction to return to the previously mated smart cover list is received, operation continues from block 1804. Likewise at block 1804, if an instruction to exit the locker feature is received, operating logic 704 exits the locker feature, and continues operation from there.

Thus, a user of the mobile phone may be provided with a more enriched user experience. For example, assuming portions of the provisioning and/customization of functions provided by example smart cover of FIGS. 13A-E are semi-persistent, and has user performed functions associated with the celebrity theme of the example smart cover, and further assuming the example smart cover of FIGS. 13A-E is replaced by the example smart cover of FIGS. 14A-F, with the “locker” feature of various embodiments of the present invention, a user may nonetheless have access to the semi-persistent provisioning and/or customization provided by the example smart cover of FIGS. 13A-E (even though they have been disabled on removal of the smart cover of FIGS. 13A-E), when performing certain functions associated with smart cover of FIGS. 13A-E. Using the end user interface example again, a user may nonetheless have the end user interface elements associated with the celebrity theme, when calling a phone number associated with the celebrity theme (e.g. to purchase concert tickets), browsing a website associated with the celebrity, chatting with other fans in a chat room associated with the celebrity and so forth, even after the example smart cover of FIGS. 13A-E has been replaced with smart cover of FIGS. 14A-F. But advantageously, when the user finished performing these functions associated with the celebrity theme of the example smart cover of FIGS. 13A-E, the end user interface experience automatically reverts back to the currently mated example smart cover of FIGS. 14a-F.

Having now described the present invention in the context of provisioning and/or customizing, including personalizing, mobile phones, as alluded to earlier, the present invention is so limited, and we turn now to describe the practice of the present invention in the context of personal digital assistants (PDAs), pocket PCs, and other mobile electronic devices or the like.

In addition to mobile phones, the smart cover of the present invention may also be adapted to attach to other types of mobile communication devices, including PDAs, pocket PCs, and two-way wireless pagers, such as the Blackberry devices produced by the Research In Motion Corporation. As described earlier, the smart cover may be an accessory cover or a housing cover, and the provisioning and/or customization may be persistent, semi-persistent, and/or transient.

For example, an exemplary embodiment in which a smart accessory cover 1500 suitable for adorning by a PDA 1520 is shown in FIG. 15. Similar to smart accessory cover 10 or 60, smart accessory cover 1500 is not a required element to complete PDA 1520, in particular, smart accessory cover 1500 does not form part of the housing of PDA 1520.

Similar to the smart accessory cover embodiments discussed above, smart accessory cover 1500 comprises a resilient semi-rigid shell including front and back portions 1504 and 1506 coupled to a side portion 1508 wherein the shell has a substantially “U”-shaped profile.

Smart accessory cover 1500 further includes electronic component 1600 having data to personalize PDA 1620.

Additionally, for the embodiment, smart accessory cover 1500 includes an aperture 1502 through which an LCD display 1522 on PDA 1520 can be seen, and a cutout 1514 adapted to allow buttons 1526, 1528, 1530, 1532, and 1534 on PDA 1520 to pass, upon adorning the smart accessory cover. Alternatively, a respective cutout for each PDA button may be provided instead.

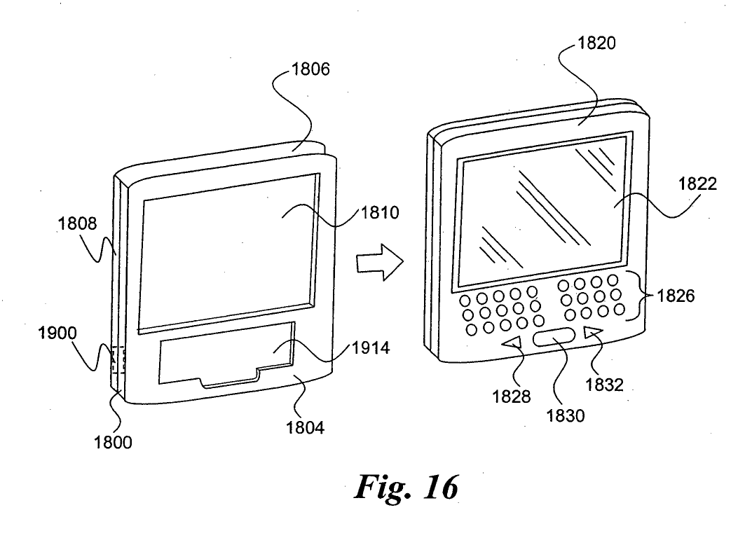

Another exemplary embodiment in which smart accessory cover 1800 is secured to a two-way wireless pager 1820 is shown in FIG. 16. As before, smart accessory cover 1800 comprises a resilient semi-rigid shell including front and back portions 1804 and 1806 coupled to a side portion 1808, wherein the shell has a substantially “U”-shaped profile.

Smart accessory cover 1800 further includes electronic component 1900 having data to personalize wireless pager 1820.

Further, for the embodiment, smart accessory cover 1800 further includes an aperture 1810 through which and LCD display 1822 on two-way wireless pager 1820 can be seen, and a cutout 1814 adapted to allow pager keypad buttons 1826 and input buttons 1828, 1830, and 1832 on two-way wireless pager 1820 to pass upon adorning smart accessory cover 1800.

As with smart accessory covers 10 and 60, while illustrated with a substantially U-shaped embodiment, smart accessory covers 1500 and 1800 are likewise not so limited, and may take on other shapes, to be adorned by non-rectangular PDA and pagers.

Accordingly, a smart cover with embedded data/instructions for provisioning/customizing (including personalizing) an electronic device has been described. While embodiments of the invention have been described in terms of the above-illustrated embodiments, one skilled in the art will recognize that the invention is not limited to the embodiments described. The invention can be practiced with modification and alteration within the spirit and scope of the appended claims.

For example, the present invention may be practiced with options to allow a user to accept or reject all or a portion of the additional functionalities and/or content to be added to the base electronic device, as result of the engagement of the “smart” accessory cove.

Another example is in some embodiments, in lieu of the employment of an electronic component, a bar code or a magnetic stripe having certain identification information be used instead to “couple” to the base electronic device (having complementary bar code or magnetic stripe “reader” capability), the type and/or location of the additional functionalities and/or contents.

Another example is the inclusion of certain anti-piracy features, such as upon installation of the added functionalities and/or contents, the same combination of smart accessory cover and base electronic device is required for the installed additional functionalities and/or content to be available and/or useable.

Thus, the description is to be regarded as illustrative instead of restrictive on the invention.

1. A cover for customizing a mobile electronic apparatus comprising:
a cover body, designed to removably mate with the mobile electronic apparatus; and
an electronic component disposed on a surface of the cover body, and having a plurality of data or location information for retrieving said data, with said data providing or customizing a plurality of functionality of the mobile electronic apparatus, including at least a first provision or customization that is semi-persistent, conditionally effective when the cover is not mated with the apparatus after an initial mating.

2. The cover of claim 1, wherein the first provision or customization is unconditionally effective when the cover is mated with the apparatus.

3. The cover of claim 1, wherein the cover is associated with a theme, and the first provision or customization is effective when a user is performing a function associated with the theme, while the cover is not mated with the apparatus.

4. The cover of claim 3, wherein the first provision or customization comprises an user interface asset associated with the theme, and the function comprises a selected one of the user accessing a website associated with the theme, and the user engaging in a chat session associated with the theme.

5. The cover of claim 3, wherein the first provision or customization comprises an user interface asset associated with the theme, and the function comprises a selected one of the user calling a callee associated with the theme, and the user messaging a recipient associated with the theme.

6. The cover of claim 3, wherein the cover body further comprises at least one exterior surface having designs disposed thereon, in support of the theme.

7. The cover of claim 1, wherein the data further include a second provision or customization that is transient, effective only when the cover is mated with the apparatus.

8. The cover of claim 7, wherein the data further comprises instructions designed to render the second provision or customization ineffective on unmating the cover with the apparatus.

9. The cover of claim 7, wherein the data further includes a third provision or customization that is persistent, effective with or without the cover being mated with the apparatus, after the initial mating.

10. The cover of claim 1, wherein the data further includes a second provision or customization that is persistent, effective with or without the cover being mated with the apparatus, after the initial mating.

11. The cover of claim 1, wherein the electronic component comprises a processor.

12. The cover of claim 1, wherein the cover body is substantially U-shaped, designed to snap onto said body of the mobile electronic apparatus from a sideway direction.

13. The cover of claim 1, wherein the cover body is an accessory cover not required to complete the mobile electronic apparatus.

14. The cover of claim 1, wherein the apparatus comprises a selected one of a wireless mobile phone, a personal digital assistant, a wireless text messaging device, a portable gaming device, and a portable media player.

15. In a mobile electronic apparatus, a method of operation, comprising:
facilitating a user of the mobile electronic apparatus in selecting a function that is associated with a cover previously mated with the mobile electronic apparatus, where performance of function is to cause a first provision or customization of functionality of the mobile electronic apparatus by the previously mated cover to be effective, even the previously mated cover is not currently mated with the mobile electronic apparatus, the first provision or customization of functionality being semi-persistent, to be conditionally effective when one of one or more functions, including the selected function, is being performed by the user, even when the previously mated cover is not currently mated with the mobile electronic apparatus; and
re-effectuating the first provision or customization of functionality of the mobile electronic apparatus, based at least in part on the selection of the function.

16. The method of claim 15, wherein the method further comprises presenting one or more previously mated covers with semi-persistent provision(s) or customization(s) for selection by the user.

17. The method of claim 15, wherein the method further comprises presenting one or more functions, including the first function, associated with the previously mated cover with semi-persistent provision(s) or customization(s) for selection by the user.

18. The method of claim 15, wherein the first provision or customization comprises a user interface asset, and the re-effectuating of the first provision or customization comprises employing the user interface asset in provisioning of end user interface for the mobile electronic apparatus, while the user is performing the function.

19. The method of claim 15, further comprising rendering the first provision or customization ineffective on umating the cover with the mobile electronic apparatus.

20. The method of claim 15, further comprising performing said first provision or customization on an initial mating of the cover with the mobile electronic apparatus.

21. A mobile electronic apparatus comprising:
means to facilitate a user in selecting a function associated with a cover previously mated with the mobile electronic apparatus, where performance of the function is to cause a first provision or customization of functionality of the mobile electronic apparatus by the previously mated cover to be effective, even the previously mated cover is not currently mated with the mobile electronic apparatus, the first provision or customization of functionality being semi-persistent, to be conditionally effective when one of one or more functions, including the selected function, is being performed by the user, even when the previously mated cover is not currently mated with the mobile electronic apparatus; and
means for re-effectuating the first provision or customization of functionality of the mobile electronic apparatus, based at least in part on the selection of the function.

22. The apparatus of claim 21, wherein said facilitating and re-effectuating means comprise
storage medium;
executable instructions stored in the storage medium, the instructions having been adapted to perform said facilitating and re-effectuating, when executed; and
at least one processor coupled to the storage to execute the instructions.

23. The apparatus of claim 21, wherein said facilitating means is adapted to present one or more previously mated covers with semi-persistent provision(s) or customizations for selection by a user.

24. The apparatus of claim 21, wherein said facilitating means is adapted to present one or more functions associated with a previously mated cover with semi-persistent provision(s) or customizations for selection by a user.

25. The apparatus of claim 21, wherein the first provision or customization comprises a user interface asset, and the re-effectuating means is adapted to cause the user interface asset to be employed in provisioning of end user interface for the mobile electronic apparatus, while the user is performing the function.

26. The apparatus of claim 21, further comprising means for rendering the first provision or customization ineffective on umating the cover with the mobile electronic apparatus.

27. The apparatus of claim 21, wherein the apparatus comprises a selected one of a wireless mobile phone, a personal digital assistant, a wireless text messaging device, a portable gaming device, and a portable media player.
